(19) United States
(12) Patent Application Publication
(10) Pub. No.: US 2005/0005158 A1
(43) Pub. Date: Jan. 6, 2005

(54) Method for compiling an active server page (ASP).Net Web service into a java compliant Web service

(76) Inventor: Eyal Alaluf, Jerusalem (IL)

Correspondence Address: KATTEN MUCHIN ZAVIS ROSENMAN, 575 MADISON AVENUE, NEW YORK, NY, 10022-2585, US

(21) Appl. No.: 10/880,396

(22) Filed: Jun. 29, 2004

Related U.S. Application Data
(60) Provisional application No. 60/483,898, filed on Jul. 2, 2003.

(51) Int. Cl. H04L 9/00

(52) U.S. Cl. 713/200

(57) ABSTRACT

A method is disclosed for an attribute compiler for compiling an active server page (ASP).Net Web service into a Java compliant Web service and enabling execution of Web applications having at least one Web service attribute. The method includes detecting at least one Web method in a .Net assembly file of a respective .Net class. The method also includes generating a Web service file comprising at least one instance of a backend component and the Web method and generating the at least one instance of a backend component for implementing the Web method, such that the active server page (ASP).Net Web service can be compiled into a Java compliant Web service.

### CROSS-REFERENCE

This application claims priority to U.S. provisional patent application Ser. No. 60/483,898 submitted Jul. 2, 2003, which application is incorporated herein in its entirety by this reference thereto.

### FIELD OF THE INVENTION

The present invention generally relates to software compilers. More specifically, the present invention relates to a method for compiling an active server page (asp).net web service into a java compliant web service capable of handling method attributes.

### BACKGROUND OF THE INVENTION

The Microsoft® .NET framework is a new platform for building integrated, service-oriented, applications to meet the needs of today's and future Internet businesses. The Net platform allows developers to take better advantage of technologies than any earlier Microsoft platform. Specifically, the .NET platform provides means for code reuse, code specialization, resource management, multi-language development, security, deployment and administration.

A .NET application can be executed on any platform that supports the .NET common language runtime (CLR). The .Net platform allows different programming languages to be integrated with one another. For example, it is possible to create a class in C++ that is derived from a class implemented in Visual Basic. The programming languages supported by the Net platform include, but are not limited to, C++ with managed extensions, C# (C-Sharp), Visual Basic, Pascal, COBOL, JavaScript, and many others. However, the CLR engine is required for execution of the source code written in these languages.

The Java programming environment has recently gained significant popularity. The Java programming language is a language that is designed to be portable enough so that it can be executed on a wide range of computers, ranging from small devices, such as personal digital assistances (PDA's), cell phones, and smart cards up to supercomputers. Computer programs written in the Java programming language are compiled into Java byte-code instructions that are suitable for execution by a Java virtual machine (JVM).

Applications designed with the .Net platform cannot execute on a JVM. As a result, developers cannot integrate the advantages inherent to .Net with the capabilities provided by the Java runtime environments. To overcome this limitation, compilers that enable the execution of .Net applications on JVM have been introduced. These compilers (hereinafter the “IL2J” compilers) decode Microsoft intermediate language (MSIL) instructions and produce Java bytecode instructions. An example of such a compiler is disclosed in U.S. patent application Ser. No. 10/453,518 entitled “Compiler and Software Product for Compiling Intermediate Language Bytecodes into Java Bytecodes” assigned to common assignee and incorporated herein by reference for all that it contains.

However, beside the need to compile MSIL instructions into Java bytecodes, there is also a need to compile other software mechanisms introduced by the Net platform, to allow full adaptation of the Java platform. Examples of such mechanisms are method attributes, particularly Web services attributes which are a sub-set of the method attributes. Generally, method attributes are used to customize the class that includes them. That is, Web service attributes allow the customization of Web services.

Web service is a software system identified by a uniform resource locator (URL), whose public interfaces and bindings are defined and described using extensible markup language (XML). In a typical Web service scenario, a business application sends a request to a service at a given URL, using the simple object access protocol (SOAP) over hypertext transfer protocol (HTTP). The service receives the request, processes it and returns a response. A simple example of a Web service is that of a stock quote service, in which the request asks for the current price of a specified stock, and the current stock price is returned in the response. Web services can be document-oriented services or method-oriented services. The XML messages that are exchanged with a document-oriented Web service are contained in a Web services description language (WSDL) file (or document). WSDL is an XML format for describing network services as a set of endpoints operating on messages containing either document-oriented or method-oriented information. The operations and messages are described abstractly, and are then bound to a concrete network protocol and message format to define a service.

Karakashian, in U.S. patent application No. 20040045005, discloses a Web service, which can be deployed using a backend component such as an Enterprise JavaBean or Java class. The operation of the Web service can be mapped to methods of the backend component. An interceptor can provide access to SOAP contents of a Web service invocation message, passing contents to and from the backend component. The interceptor writes response data received from the backend component to a Web service response message, which can be sent to the client invoking the Web service. A codec, such as a serializer or deserializer, can be used to convert data in the Web service invocation message and invocation response message between XML representations and Java objects for use with the backend component.

Matheson, in U.S. Pat. No. 6,546,433, describes an external function integration system, which displays attributes of external function stored in a symbol table, and receives a corresponding function invocation from a developer.

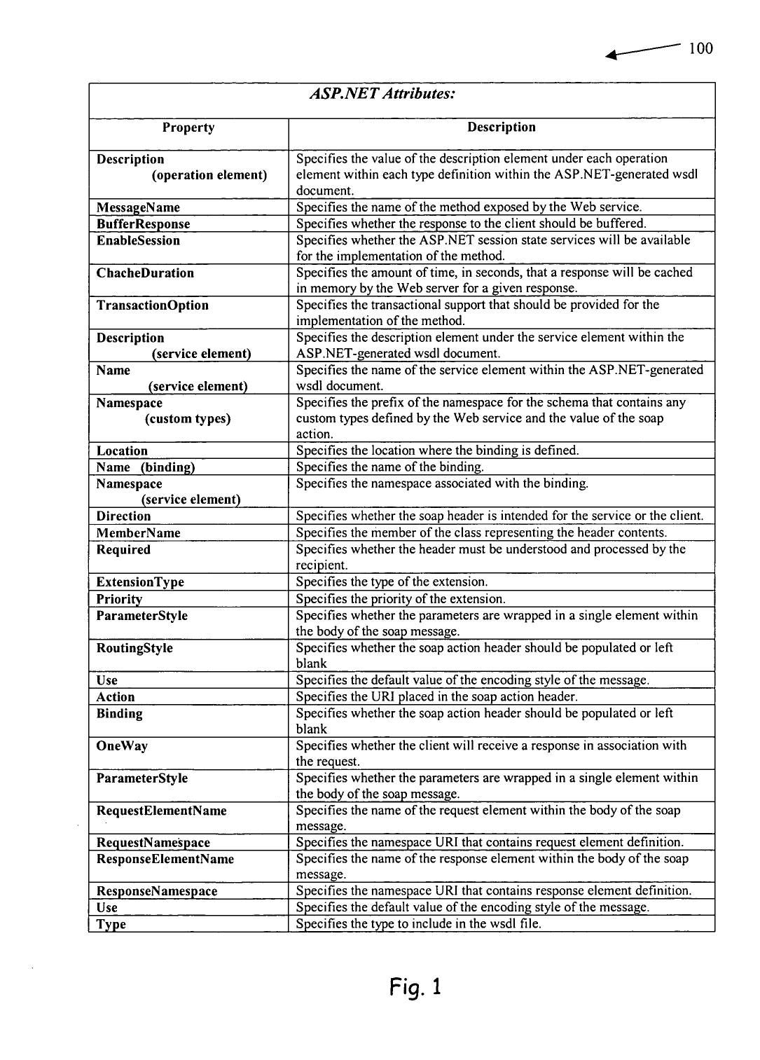

In the .NET framework the ASP.NET package is used for building Web applications and XML based Web services. ASP.NET pages execute on the server and generate markup language code, such as HTML or XTML, which is sent to a desktop or mobile browser. ASP.NET Web service files contain server-side code written in any .NET compatible language (e.g., Visual Basic, C#, etc.). The Web services may include a plurality of Web service attributes, each providing a particular customization of the XML Web service. The developer uses the properties of these attributes to configure the behavior of the Web service. An exemplary list of the ASP.Net Web service attributes and their properties 100 is provided in prior art FIG. 1. The .Net framework allows developers to devolve advanced Web applications and services using the ASP.Net framework. However, these Web services cannot be executed on the Java runtime environment.

Therefore, it would be advantageous to provide a software product capable of compiling ASP.Net Web service attributes into a Java compliant executable code.

### SUMMARY OF THE INVENTION

Accordingly, it is a principal object of the present invention to provide a software product capable of compiling ASP.Net Web service attributes into a Java compliant executable code

It is another object of the present invention to provide software development of ASP.Net Web services as EJB's, wherein the realization and the execution of these Web services is performed by means of an ASP.Net engine

A method is disclosed for an attribute compiler for compiling an active server page (ASP).Net Web service into a Java compliant Web service and processing Web applications having at least one Web service attribute. The method includes detecting at least one Web method in a Net assembly file of a respective Net class. The method also includes generating a Web service file comprising at least one instance of a backend component and the Web method and generating the at least one instance of a backend component for implementing the Web method, such that the active server page (ASP).Net Web service can be compiled into a Java compliant Web service.

The present invention discloses an attribute compiler capable of compiling Web service attributes defined in ASP.Net framework into a computer executable code compliant with the Java programming language. This allows programmers to develop Web services and Web applications using the .Net platform and run these service and applications on the Java runtime environment.

Additional features and advantages of the invention will become apparent from the following drawings and description.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

### BRIEF DESCRIPTION OF THE DRAWINGS

FIG. 1 is an exemplary list of the active server page (ASP).Net Web service attributes, as is known in the prior art;

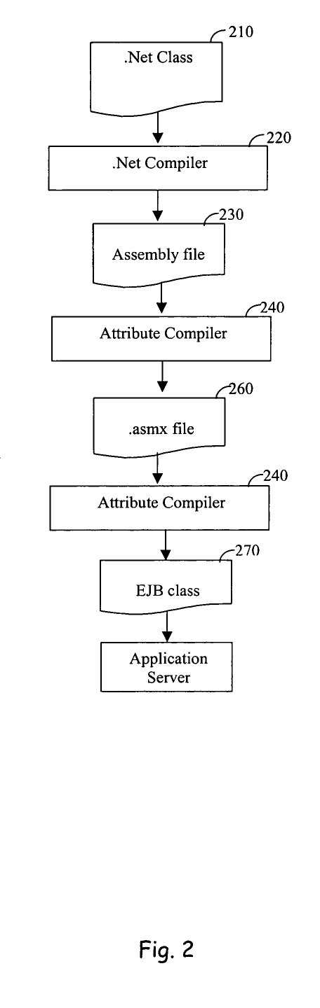

FIG. 2 is a non-limiting process flow for compiling Web service attributes in accordance with an exemplary embodiment of this invention;

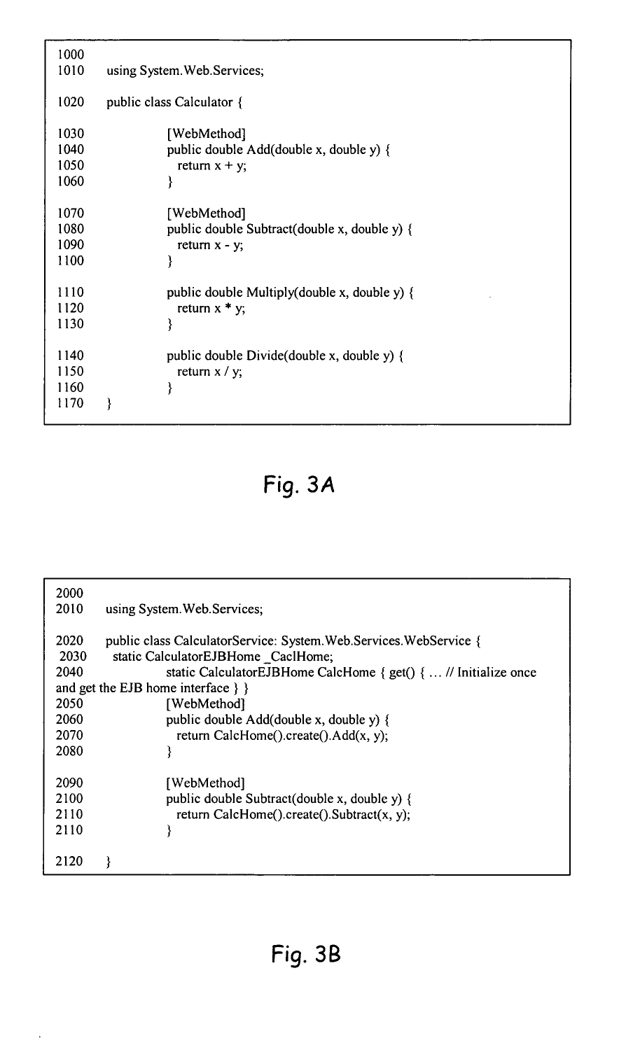

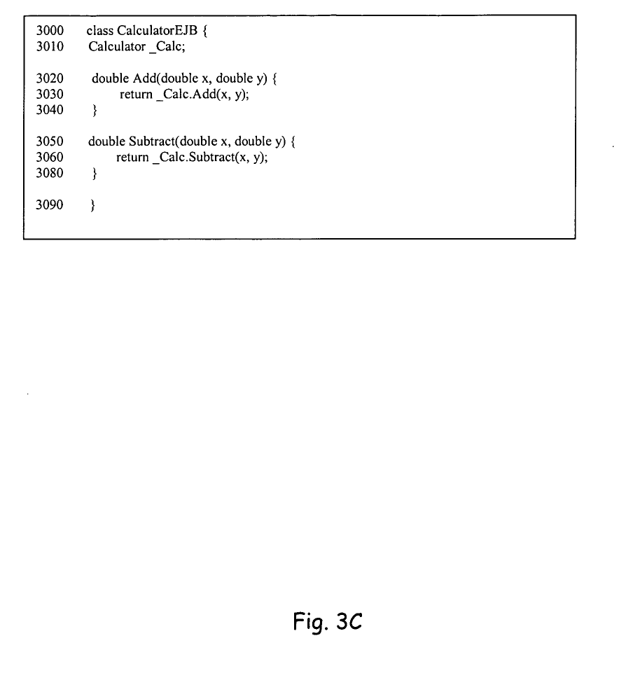

FIG. 3A is a non-limiting example of a .Net class that includes Web service attributes that can be operated on by the compiler of the present invention;

FIG. 3B is a non-limiting example of an .asmx class file generated by the attribute compiler of the present invention;

FIG. 3C is a non-limiting example of an EJB component generated by the attribute compiler of the present invention;

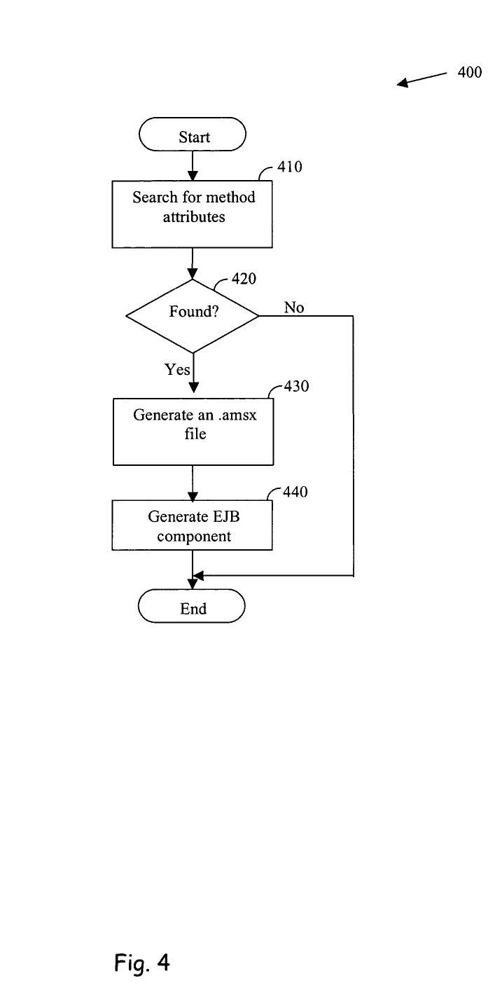

FIG. 4 is a non-limiting flowchart describing the operation of an attribute compiler, in accordance with an exemplary embodiment of this invention; and

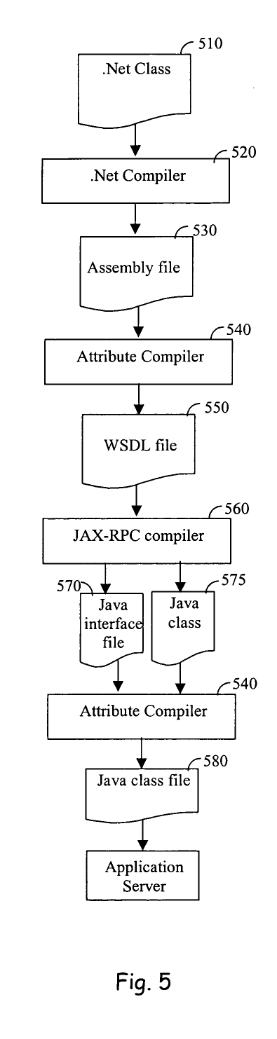

FIG. 5 is a non-limiting process flow for compiling Web service attributes in accordance with an exemplary embodiment of this invention.

### DETAILED DESCRIPTION OF THE INVENTION

Reference is now made to FIG. 2, a non-limiting illustration of a process flow for compiling ASP.Net Web service attributes, in accordance with an exemplary embodiment of the present invention. Initially, a software developer creates a .Net class 210 that includes at least one method that comprises a definition of a Web service attribute. For example, the method includes the [WebMethod] declaration. The Net class 210 comprises source code written in any programming language supported by the .Net platform. The programming languages supported by the .Net platform may be, but are not limited to, C++ with managed extensions, C# (C-Sharp), Visual Basic, Pascal, Cobol, JavaScript and many others.

FIG. 3A shows the source code listing for an exemplary .Net class named “Calculator.” The “Calculator” class includes two methods defined using Web service attributes. These are the “add” method and the “subtract” method, shown in lines 1030 and 1070, respectively. The Web service attribute in these methods is announced by the statement [WebMethod], which exposes the “add” and “subtract” methods as Web service functions.

Subsequently, referring again to FIG. 2, Net class 210 is compiled into a Net assembly file 230 using a .Net compiler 220. As discussed above, the .Net compiler 220 consists of several compilers, each targeted to a different programming language supported by the Net platform. The .Net compiler 220 generates the assembly file 230, which is comprised of functional building blocks of the application, and includes all the methods defined in the Net class 210. Thus, assembly file 230, which is related to the class “Calculator,” includes methods declared as Web service attributes, as well as other methods found in the .Net class “Calculator.”

The attribute compiler 240 generates an .asmx class file 260. Web service operations (e.g., “Add” and “Substrate”) are exposed through the .asmx class file 260, which acts as the base URL for clients calling the Web service. The .asmx class file 260 includes methods that are defined using the [WebMethod] attribute.

FIG. 3B shows non-limiting source code listing for an exemplary .asmx class file 260 produced by attribute compiler 240, and related to the Net class shown in FIG. 3A. The .asmx class file 260 includes the prototype of each method defined using the declaration [WebMethod] (shown in lines 2050 and 2090). In addition, .asmx class file 260 directly invokes a session enterprise Java bean (EJB) component 270 generated by attribute compiler 240. The generated EJB component 270 exposes methods with the same prototype as those marked by the [WebMethod] attribute.

As can be seen in line 2030 of FIG. 3B, the EJB home interface “CalculatorEJBHome” is initialized (EJB home interfaces are factories of the EJB's) and the EJB interface “CalculatorEJB” is retrieved (i.e., returned by the “create” method of the home interface). The call to the “Add” and the “Subtract” methods is performed through the “CalculatorEJB” interface (shown in lines 2070 and 2110). EJB component 270 directly invokes the user class (e.g., Net class 210).

FIG. 3C shows non-limiting source code listing for an exemplary EJB component 270. In lines 3030 and 3060 the “Add” and “Subtract” in the user class 210 are called through an instance of the object “Calculator.” The generated EJB component 270 further includes a template that defines necessary methods, such as the “create” and “get” and several XML files that describe it.

The resultant Web application is packaged into an enterprise application archive (EAR) file that contains XML files that describe the Web application, Web archive (WAR) files generated from the .asmx class file 260 and Java archive (JAR) files of EJB component 270, along with its XML descriptor files. An EAR file is a zip file comprised of XML files, JAR files for EJB components and WAR files for Web applications. Each WAR file is a zip file composed of XML files (e.g., html files and images) and JAR files that contain the classes to be used in the Web application. A JAR file is a zip file composed of Java class files and resources (ordinary files) used by the Java classes. The EAR file is generated by the attribute compiler 240. The WAR files are generated by the IL2J compiler that compiles .asmx class file 260 into WAR files.

The attribute compiler may operate in conjunction with the IL2J compiler, which eventually compiles the user defined Net class (e.g., .Net class 210) to a Java class. Therefore, the resultant Web application or service consists of pure Java executable code that can be executed over any Java runtime environment (e.g., the JVM). At runtime, i.e., when the Web service is executed, a request to a service at a given URL is sent using the SOAP over the HTTP.

The request, which is a SOAP message, includes the URL (e.g., .asmx class file) to be executed, the invocation method within this URL and the values of the method's parameters, if they exist. The received SOAP message is inspected to detect the method to be invoked. As a result, the class defined by .asmx file 260 is searched and invoked, which then calls an EJB instance of the EJB component 270 that includes the method requested to be activated. Once such an object is found, EJB component 270 is called and the method parameters are passed to it. Consequently, EJB component 270 calls the requested method in Net class 210 through an instance of the object class that it maintains.

FIG. 4 is a non-limiting flowchart 400 describing the operation of the attribute compiler, in accordance with an exemplary embodiment of the present invention. The attribute compiler receives assembly files created by .Net compiler 220 as its input. At step 410 the received assembly file is scanned for the purpose of detecting Web service attributes defined in the .Net class. At step 420, a check is performed to determine if at least one Web service attribute was found, and if so, execution continues with step 430; otherwise, execution is terminated. At step 430, an .asmx file (e.g., .asmx file 260) is generated.

The class defined within the .asmx file includes the prototypes for each method that was defined with a Web service attribute, for example, methods declared using the [WebMethod] statement. The Web service includes an instance of the backend component that invokes these methods. At step 440, a backend component that includes implementation of the methods defined in the .asmx file is generated. An implementation of the method found in the backend component merely comprises an instance of the .Net class defined by the user, e.g., .Net class 110. The backend component may be, but is not limited to, an EJB component, a Java message service (JMS) component, a Java class and the like.

It should be empathized that compiling Web service attributes, as described herein, does not require handling semantic differences between the programming languages supported by the Net platform and Java programming language. Therefore, any conversion of .Net proprietary variable and data structure types (e.g., Enum) to Java variable types, as well as modification of functionalities not supported by the Java language (e.g., passing parameters by reference) is not required. It should be further empathized that the present invention allows software development of ASP.Net Web services as EJB's, while the realization and the execution of these Web services is performed by means of an ASP.Net engine.

FIG. 5 is a non-limiting illustration of a process flow for compiling ASP.Net Web service attributes, in accordance with an exemplary embodiment of the present invention. A software developer creates a .Net class 510 that includes at least one method that comprises a definition of a Web service attribute. The .Net Class 510 comprises source code written in any programming language supported by the .Net platform. Subsequently, .Net class 510 is compiled into a Net assembly file 530 using .Net compiler 520.

.Net compiler 520 generates .Net assembly file 530, which is comprised of functional building blocks of the application, and includes all the methods defined in .Net class 510. In order to compile the Web service attributes, attribute compiler 540 generates a Web services description language (WSDL) file 550, which is subsequently compiled using a Java tool 560 to a Java interface 570. Java tool 560 is exemplified by a JAX-RPC compiler which simplifies the process of building Web services that incorporate XML-based remote procedure calls (RPC's).

WSDL file 550 is an XML format for describing network services as a set of endpoints operating on messages. The operations and messages are described abstractly, and then bound to a concrete network protocol and message format to define an endpoint. Java interface file 570 is a Java construct that only includes methods defined using Web service attributes, but does not provide any implementation of these methods. In addition, Java tool 560 outputs a Java class 575 that uses a template class, which needs to be implemented by the developer.

In this embodiment, a Java class file 580 is generated by attribute compiler 540, which replaces template Java class 575. Java class 580 implements each of the methods defined in Java interface 570 by creating an instance of the Net class 510 and calling the exposed methods through that instance. The files generated by Java tool 560 and Java class 580 are packaged in a Web archive file (WAF), which is subsequently sent to an application server using a SOAP protocol for execution.

It should be noted that the attribute properties are mapped to a format compliant with Java tool 560. For example, the properties of the WebMethod attribute described in detail in FIG. 1 are: BufferResponse, CacheDuration, Description, EnableSession, MessageName, and TransactionOption. Here, the property MessageName, which specifies the name of the method exposed by the Web service, is mapped to a Java wrapper method name.

As per the above, the present invention provides a software product capable of compiling ASP.Net Web service attributes into Java complaint executable code

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

1. A method for an attribute compiler for compiling an active server page (ASP).Net Web service into a Java compliant Web service and enabling execution of Web applications having at least one Web service attribute, the method comprising:
detecting at least one Web method in a Net assembly file of a respective Net class;
generating a Web service file comprising at least one instance of a backend component and said Web method; and
generating said at least one instance of a backend component for implementing said Web method,
such that the active server page (ASP).Net Web service can be compiled into a Java compliant Web service.

2. The method for an attribute compiler of claim 1, wherein said Web service file exposes at least one method with the same prototype of said at least one Web method.

3. The method for an attribute compiler of claim 2, wherein said at least one instance of a backend component generated by the attribute compiler invokes said at least one Web method defined in said respective Net class.

4. The method for an attribute compiler of claim 1, further comprising the step of:
generating an enterprise application archive (EAR) file, wherein a Web application is packaged into an enterprise application archive (EAR) file that contains files that describe the Web application.

5. The method for an attribute compiler of claim 4, wherein said EAR file comprises at least:
Java archive (JAR) files of said at least one instance of a backend component;
extensible markup language (XML) describing the Web service; and
Web archive (WAR) files generated from said Web service file.

6. The method for an attribute compiler of claim 1, wherein said Web method comprises at least an ASP.Net attribute definition.

7. The method for an attribute compiler of claim 1, wherein said Web service file is at least an .asmx file.

8. The method for an attributed compiler of claim 3, wherein said at least one instance of a backend component is at least one of:
an enterprise Java bean (EJB)component;
a Java message service component; and
a Java class.

9. The method for an attribute compiler of claim 8, wherein said at least one instance of a backend component comprises extensible markup language (XML) descriptor files.

10. The method for an attributed compiler of claim 3, wherein the Web method implementation in said at least one instance of a backend component further comprises providing an instance of said .Net class.

11. The a method for an attribute compiler of claim 1, wherein said assembly Net class is generated by a Net compiler.

12. The method for an attribute compiler of claim 11, wherein said .Net compiler is capable of compiling at least one of the following programming languages:
C++ with managed extensions;
C#;
Visual Basic;
Pascal;
Cobol;
Java; and
Jscript.

13. A computer executable code for compiling an active server page (ASP).Net Web service into a Java compliant Web service and enabling execution of Web applications having at least one Web service attribute, said code comprising the steps of:
detecting at least one Web method in a .Net assembly file of a respective .Net class;
generating a Web service file comprising at least one instance of a backend component and said Web method; and
generating said at least one instance of a backend component for implementing said web method,
such that the active server page (ASP).Net Web service can be compiled into a Java compliant Web service.

14. The computer executable code of claim 13, wherein said Web service file exposes at least one method with the same prototype of said at least one Web method.

15. The computer executable code of claim 14, wherein said backend component generated by the attribute compiler invokes said at least one Web method defined in said respective .Net class.

16. The computer executable code of claim 13, further comprising the step of:
generating an enterprise application archive (EAR) file, wherein a Web application is packaged into an enterprise application archive (EAR) file that contains files that describe the Web application.

17. The computer executable code of claim 16, wherein said EAR file comprises at
least: JAR files of said EJB component;
XML describing the Web service; and
WAR files generated from said web service file.

18. The computer executable code of claim 13, wherein said Web method comprises at least an ASP.Net attribute definition.

19. The computer executable code of claim 13, wherein said Web service file is an .asmx file.

20. The computer executable code of claim 15, wherein said at least one instance of a backend component is at least one of:
an EJB component;
a Java message service component; and
a Java class.

21. The computer executable code of claim 20, wherein said at least one instance of a backend component comprises XML descriptor files.

22. The computer executable code of claim 15, wherein the Web method implementation comprises an object which is an instance of said .Net class.

23. The computer executable code of claim 13, wherein said assembly .Net class is generated by a .Net compiler.

24. The computer executable code of claim 23, wherein said Net compiler is capable of compiling at least one of the following programming languages:
C++ with managed extensions;
C#;
Visual Basic;
Pascal;
Cobol;
Java; and
Jscript.
